(19) United States
(12) Patent Application Publication
(10) Pub. No.: US 2020/0156273 A1
(43) Pub. Date: May 21, 2020

(54) RAZOR BLADE USAGE INDICATOR

(71) Applicant: William Fitzgerald, Adel, IA (US)

(72) Inventor: William Fitzgerald, Adel, IA (US)

(21) Appl. No.: 16/430,762

(22) Filed: Jun. 4, 2019

Related U.S. Application Data
(60) Provisional application No. 62/769,359, filed on Nov. 19, 2018.

(51) Int. Cl. B26B 21/40; B26B 21/52

(52) U.S. Cl. CPC B26B 21/4087; B26B 21/52

(57) ABSTRACT

A razor blade usage indicator or counter is mounted on the handle of the razor and moves upwardly and downwardly along the handle as a representation of the number of uses of the razor. Before or after each use, the indicator or counter is moved one position along the handle. The indicator or counter can roll or slide along the handle. Multiple counters may be color-coded for use by different people in a household.

### CROSS-REFERENCE TO RELATED APPLICATIONS

This application claims priority to Provisional Application U.S. Ser. No. 62/769,359, filed on Nov. 19, 2018, which is herein incorporated by reference in its entirety.

### FIELD OF THE INVENTION

The invention relates to razor blades, and particularly, to a device for counting the number of uses of the razor so a user can replace the razor or the blades after a predetermined number of uses.

### BACKGROUND OF THE INVENTION

Razors are available in numerous designs and styles for use in shaving body hair. One common razor design has a handle with a detachable head or cartridge which carries one or more blades. Another common design is a disposable razor, wherein the handle and head are integrally formed. The blades of all razors have a limited life and must be periodically replaced. Thus, the cartridge style razors require new cartridges and disposable razors are thrown away and replaced with a new razor. The life of the blades depends largely upon user preference, as well as upon the quality of the hair being shaved. For example, some hair is soft and fine, while other hair is thick and course. Using a blade beyond its best performance can be a discomfort to the user. It is difficult for a user to know how many times his or her razor has been used, other than by the tactile feel when shaving their body hair, for example on their face or legs.

Prior art blade usage counters are typically manufactured in the razor handle, with multiple parts, adding costs to production of the razor. Also, these prior art counters use small numbers and do not provide sufficient visual reminders to the user to change the count before or after each use of the blade. For example, see U.S. Pat. Nos. 2,812,575, 3,476,077 and 5,119,557.

Replacing dull blades, either in the cartridge style razor or a whole disposable razor, entails cost to the user. Therefore, premature blade replacement adds cost to the user and extended use causes discomfort to the user. Therefore, there is a need for an indicator and method to easily count the number of times each blade is used for shaving.

Accordingly, a primary objective of the present invention is the provision of a visual indicator for use with a razor to count the number of uses of the razor blade.

Another objective of the present invention is the method of tracking the number of uses of a razor blade using a visual indexing mechanism on the handle of the razor.

Yet another objective of the present invention is the provision of a razor blade usage counter which can be manufactured as original equipment on razors or as an after market add-on to the razor.

Still another objective of the present invention is the provision of a razor blade use counter which moves upwardly and downwardly along the razor handle to indicate the number of times the blade has been used and to remind the user to index the counter before or after each use.

A further objective of the present invention is the provision of a razor blade counter which benefits the user by avoiding use of dull blades and which benefits blade manufactures by increasing sales of replacement razors and blades.

Another objective of the present invention is the provision of a counter for use on a cartridge or disposable razor which moves along the razor handle, with each movement representing one use of the razor.

A further objective of the present invention is the provision of a razor blade use counter which can be manufactured as OEM or for aftermarket application.

Yet a further objective of the present invention is the provision of a razor blade usage counter which rolls or slides along a length of the handle to provide a visual indicium of the number of uses of the razor.

Another objective of the present invention is the provision of a device for counting razor blade uses which is simple to use, economical to manufacture, and safe and durable in use.

These and other objectives become apparent from the following description of the invention.

### BRIEF DESCRIPTION OF THE DRAWINGS

FIG. 1 is a side elevation view of a razor having a blade-usage indicator of the present invention positioned thereon.

FIG. 2 is an elevation view of a first embodiment of a blade-usage visual indicator for use on a razor, as shown in FIG. 1, in accordance with the present invention.

FIG. 3 is an end view of the visual indicator shown in FIG. 2.

FIG. 4 is an elevation view showing an alternative embodiment of the indicator of the present invention, as positioned on the handle of a razor.

FIG. 5 is an elevation view of a razor with another alternative embodiment of a sliding indicator, in accordance with the present invention.

FIG. 6 is a sectional view taken along lines 6-6 of FIG. 5, and with the razor and indicator separated for illustration.

FIG. 7 is an elevation view of a razor having a fourth embodiment of a sliding blade-usage indicator, in accordance with the present invention.

FIG. 8 is a sectional view taken along lines 8-8 of FIG. 7.

FIG. 9 is and end view of the indicator shown in FIG. 7.

### DETAILED DESCRIPTION OF THE INVENTION

The drawings show four embodiments of a razor blade usage indicator in accordance with the present invention. It is understood that additional embodiments are also contemplated, without departing from the scope of the present invention.

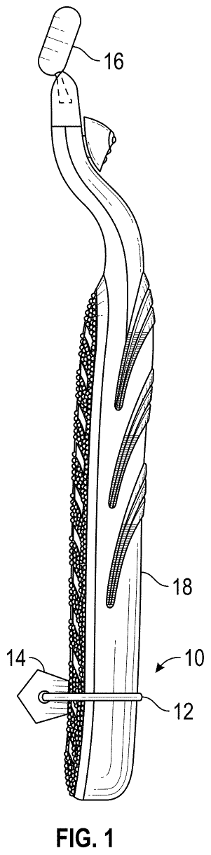

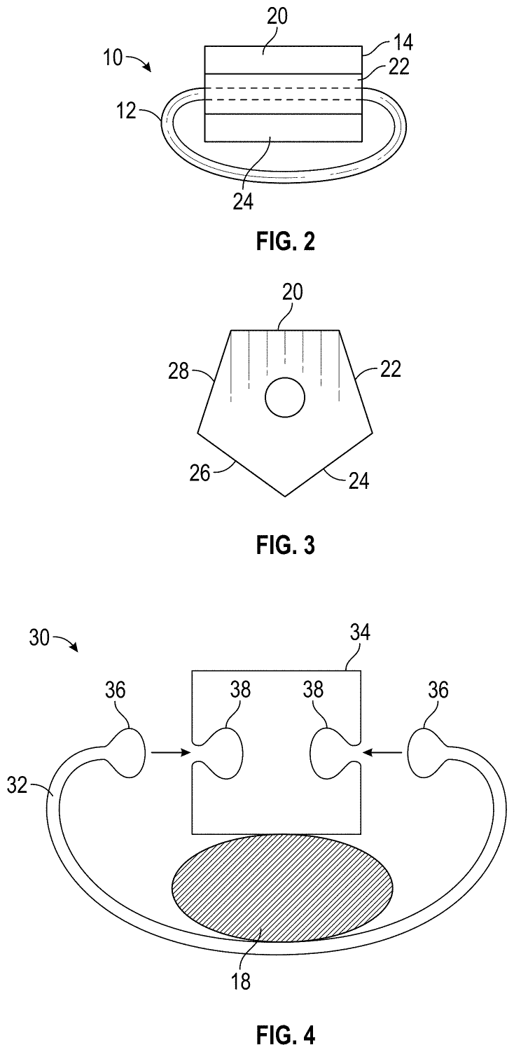

In the first embodiment shown in FIGS. 1 and 2, the indicator 10 includes an elastic band 12 with a polygonal member 14. The polygonal member 14 includes a hole, through which the band 12 extends. FIG. 2 shows the polygonal member 14 as having 5 sides, though more or less sides may be utilized. Thus, the polygonal member 14 has at least three sides, and may have 10 or more sides. Each side is preferably numbered sequentially to correspond to a number of blade uses.

The following description is for the five-sided indicator 10 shown in FIGS. 1-5. It is understood that other multi-side indicators function in a similar manner.

As shown in FIG. 1, the indicator 10 has a band 12 is adapted to extend around the handle 16 of a razor 18. The razor 18 may be any commercially available razor. The indicator 10 can be initially positioned at the bottom or top of the handle, and on the front, back or either side of the handle 16. The indicator 10 is adapted to roll up or down the handle 16, with each rotation of the member 14 corresponding to one use of the razor blade. Thus, the first side 20 of the member 14 corresponds to the first use of the blade. Then, the indicator is rolled up or down the handle, such that the second side 22 of the member 14 indicates a second use of the blade. Before or after each use of the razor, the indicator can be rolled to expose the next side of the member 14, and sequence through the third side 24, the fourth side 26, and the fifth side 28. After the fifth use of the razor 18, the indicator 10 can be rolled further up the handle after each use, with the sides 20-28 corresponding to uses 6-10, respectively, of the razor 18. After a desired number of uses of the razor, the user can replace the blade cartridge or start with a new disposable razor, with the indicator 10 moved to the starting position on the razor with the new cartridge or moved to the new disposable razor.

A second embodiment of an indicator 30 is shown in FIG. 4. The indicator 30 includes a band 32 and a polygonal member 34. The band 32 has male ends 36 which are press fit into female sockets 38 on opposite ends of the polygonal member 34. The assembled band 12 and polygon member 34 fits over the handle 16 of the razor 18, and can be rolled up or down the handle in a manner similar to that described above with respect to the indicator 10, so as to count the number of uses of the blade.

Indicators 10 and 30 are aftermarket products which can be used with any commercially available razor. The bands 12, 34 and/or the polygonal members 14, 34, may have different colors for use on different razors, such as for a man and woman in the same household.

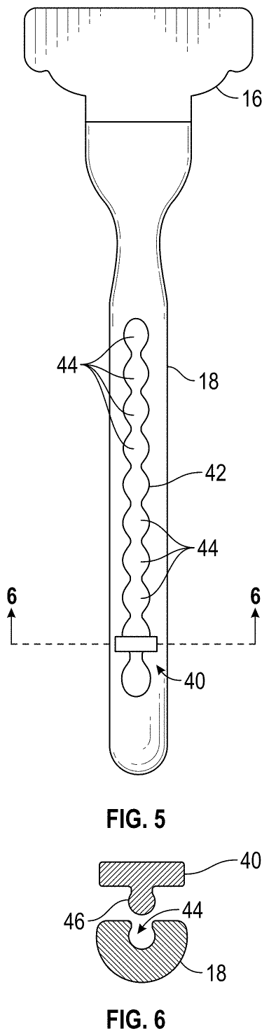

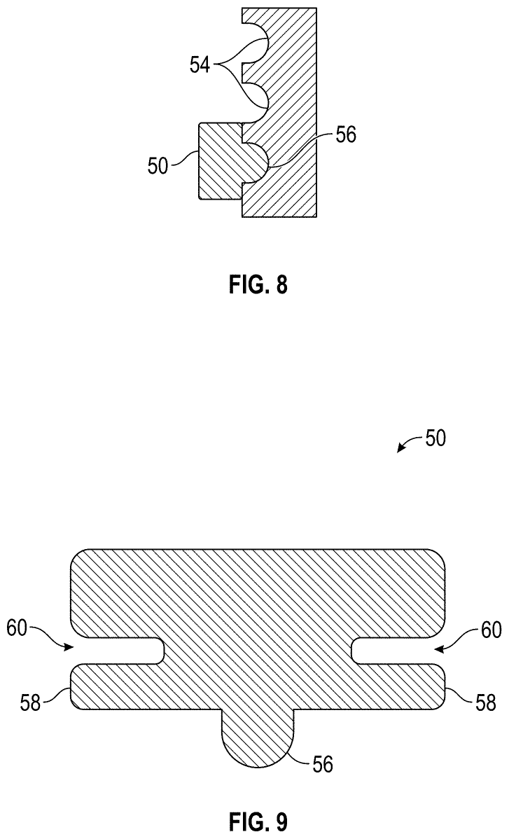

The visual indicator of the present invention may also be formed as original equipment on the razor, such as in the embodiments shown in FIGS. 5-8. More particularly, in the indicator 40 shown in FIGS. 5 and 6, the razor handle 16 includes a slot 42 formed with a plurality of notches, teeth, or steps 44. The notches 44 may be numbered. The indicator 40 includes a tab or button 46 which slidingly fits within the slot 42 and can be sequentially moved upwardly or downwardly along the handle 16, with each notch 44 indicating a new or separate use of the razor blade. Thus, with the indicator 40 starting at either the bottom or top end of the slot 40, the user moves the indicator one notch before or after each use of the razor. When the indicator 40 reaches the opposite end of the slot 42, or the desired numbered notch, the user knows that it is time to replace the blade cartridge or the disposable razor.

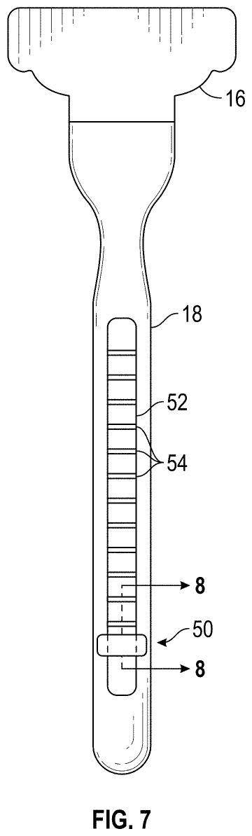

A further embodiment of an original equipment indicator 50 is shown in FIGS. 7-9. In this embodiment, the razor handle 16 has a slot 52 with a plurality of detents or steps 54, and the indicator 50 has a tab or button 56 for receipt in the detents 54. The steps 54 may be numbered. The indicator 50 can be moved up or down along the handle 16, with each step corresponding to one use of the razor blade, similar to the indicator 40.

It is understood that the indicators 40 and 50 are retained in the slot in any convenient manner, such as by flanges 58 which form a slot 60 in the indicator to interlock with the opposite side edges of the slots 42, 52, respectively, as shown in FIG. 9, so that the indicator ratchets along the handle.

Thus, whether the indicator is OEM or after market, the indicator provides a visual reminder to the user to change or index the indicator before or after each use of the blade so that blade uses can be counted. Then the user can replace the blade, cartridge, or razor before the blade becomes too dull, which will increase sales of replacement blades and razors by manufacturers.

The invention has been shown and described above with the preferred embodiments, and it is understood that many modifications, substitutions, and additions may be made which are within the intended spirit and scope of the invention. For example, the design, size and shape of the counter indicator 10 can vary from that shown in the drawings, depending on various factors, such as manufacturing costs.

From the foregoing, it can be seen that the present invention accomplishes at least all of its stated objectives.

What is claimed:

1. A blade usage indicator for use with a razor having a handle, a head, and a blade, comprising:
an indicator movable on the handle with each use of the blade, whereby the position of the indicator on the handle corresponds to a number of uses of the blade.

2. The blade usage indicator of claim 1 wherein the indicator moves along a length of the handle.

3. The blade usage indicator of claim 1 wherein the indicator rolls along the handle.

4. The blade usage indicator of claim 1 wherein the indicator slides along the handle.

5. The blade usage indicator of claim 1 wherein the indicator ratchets along the handle razor.

6. The blade usage indicator of claim 1 wherein the indicator includes a band encircling the handle.

7. The blade usage indicator of claim 1 wherein the handle includes a slot, and the indicator in mounted in the slot.

8. The blade usage indicator of claim 1 wherein detents are provided on one of the indicators or the handle.

9. The blade usage indicator of claim 1 wherein the handle includes a plurality of steps and the indicator moves along the steps.

10. A method of tracking a number of uses of a razor having a blade, comprising:
indexing a visual indicator on a handle of the razor by moving the indicator up or down the handle each time the razor is used.

11. The method of claim 10 wherein the indicator is indexed by rolling along the handle.

12. The method of claim 10 wherein the indicator is indexed by sliding along the handle.

13. The method of claim 10 wherein the indicator is indexed by a plurality of steps on the handle.

14. The method of claim 10 wherein the indicator ratchets on the handle.

15. A counter for a cartridge or disposable razor having a handle and a blade, comprising:
an indicator mounted on the handle for movement along the handle, wherein each movement of the indicator represents one use of the razor.

16. The counter of claim 15 wherein the indicator slides along the handle.

17. The counter of claim 16 wherein the handle includes a plurality of steps along which the indicator climbs.

18. The counter of claim 15 wherein the indicator rolls along the handle.

19. The counter of claim 15 wherein the indicator is polygonal in cross section.

20. The counter of claim 19 wherein the indicator has a band to extend around the handle.
